(19) United States
(12) Patent Application Publication
(10) Pub. No.: US 2011/0127120 A1
(43) Pub. Date: Jun. 2, 2011

(54) METHOD FOR PRODUCING A BRAKE CALIPER, MACHINING TOOL FOR CARRYING OUT THE METHOD, BRAKE CALIPER PRODUCED USING THE METHOD, AND DISK BRAKE HAVING A CALIPER OF SAID TYPE

(75) Inventors: Martin Stumpf, Lampertheim (DE); Peter Kramer, Reilingen (DE)

(73) Assignee: WABCO RADBREMSEN GMBH, Mannheim (DE)

(21) Appl. No.: 13/056,115

(22) PCT Filed: Jul. 23, 2009
(86) PCT No.: PCT/EP2009/005358

§ 371 Date: Jan. 26, 2011

(30) Foreign Application Priority Data
Jul. 31, 2008 (DE) 10 2008 035 753.7

(51) Int. Cl. F16D 55/226; F16D 65/02; B23P 13/00

(52) U.S. Cl. 188/71.1; 188/219.1; 29/557

(57) ABSTRACT

The invention relates to a method for producing a caliper for a caliper-type disk brake, wherein the caliper has the following: a brake-application-side caliper section (10) with at least one support surface (22.1, 22.2) for absorbing clamping forces during braking, a rim-side caliper section which is formed in one piece with the brake-application-side caliper section 912), and a first recess (14) which is situated between the two caliper sections and into which at least one brake disk projects at least in sections in the installed state. It is provided according to the invention that, to form the support surface, a machining tool (40) is moved through the first recess into the region in which the support surface is to be formed.

The invention relates to a method for producing a brake caliper of a disk brake, particularly for commercial vehicles, wherein the caliper comprises the following:

a brake application-side caliper section comprising at least one support surface for absorbing the clamping forces during braking,

a rim-side caliper section designed integral with the brake application-side caliper section, and

a first cut-out, which is located between the two caliper sections and into which at least some sections of at least one brake disk protrudes in the installed state.

A method for the type mentioned above is known, for example, from DE 195 15 063 C2. To this end, a machining tool for forming the support surface is introduced into the interior of the caliper through a dedicated working opening. Comparable production methods are known from EP 1 881 472 A1, DE 10 2005 054 402 B4, and DE 10 2007 001 960 A1, which refers to the same brake as DE 10 2007 041 658 A1. Forming the working opening for inserting the machining tool results in a weakening of the brake caliper. Furthermore, additional measures are required in order to close the working opening after machining, wherein the closure also must be tightly sealed.

The solutions according to EP 1 160 480 A2 and U.S. Pat. No. 6,811,004 B1 take a different approach. Here, the support surface is formed on a separate component, which is introduced into the interior of the caliper only after the final machining operation and anchored in a large opening at the caliper end. This solution is complex and poses sealing problems.

JP2004-353850 A1 shows a design of an axial groove for rotational locking by way of a miller.

Finally, WO 03/023244 A1 and DE 698 24 731 T2 show solutions, according to which the caliper is divided, and the brake application-side caliper section is therefore not designed integral with the rim-side caliper section. To this end, for forming the support surface, the two caliper sections are separated from each other, so as to ensure access thereto. In this solution, the connecting elements for coupling the two caliper sections to each other are subjected to considerable stresses during operation.

In contrast, the invention relates to a brake having an integrally formed, closed caliper, the interior of which is very difficult to access.

It is the object of the invention to refine the production method according to DE 195 15 063 C2 in such a way that the complexity is reduced, the caliper is not weakened, and no additional connecting elements are required, which are exposed to high stresses during operation.

According to the invention, the object is achieved in that, in order to form the support surface, a machining tool is moved through the first cut-out into that region in which the support surface is to be formed.

The invention is based on the realization that when using the cut-out, into which the brake disk protrudes in the installed state so as to introduce the machining tool for forming the support surface, an additional working opening is not required, even if the caliper is integrally formed, and the support surface does not have to be formed outside of the caliper.

The invention further creates a method for producing a caliper of a disk brake, particularly for commercial vehicles, wherein the caliper comprises the following:

a brake application-side caliper section comprising at least one support surface for absorbing the clamping forces during braking,

a rim-side caliper section designed integral with the brake application-side caliper section, and

a second cut-out located between the two caliper sections for installing/removing at least one brake pad,

characterized in that

in order to form the support surface, a machining tool is moved through the second cut-out into that region in which the support surface is to be formed.

In other words, according to the invention the machining tool can also be introduced through the installation/removal opening for the brake pad into the interior of the caliper in order to form the support surface.

According to a particularly preferred embodiment of the invention, the support surface is flat at least in some sections.

In addition, or as an alternative, however, it may also be provided that the support surface, at least in some sections, has the shape of a groove.

It is further preferred for the groove to have an arc-shaped, and particularly circular arc-shaped, contour.

The design of the support surface depends on the remaining conditions in the brake, notably the brake application device typically disposed on the interior of the caliper.

According to a particularly preferred embodiment of the invention, the machining tool comprises an L-shaped mounting and, for the purpose of displacement into a working position, can be adjusted in a translatory and rotatory fashion about an axis in the direction of the longitudinal extension of one of the limbs of the “L” with respect to the caliper.

When speaking of movements with respect to the caliper here, these movements can be caused by moving the machining tool. In addition, or as an alternative, however, the caliper may also perform complementary movements with respect to the tool. The invention, of course, also covers solutions in which both the machining tool and the caliper are moved or displaced. However, this applies only to the movements/displacement described hereinafter.

According to the invention, it is further preferred when in a first step, the limb of the “L” comprising the machining tool is displaced into the first or the second cut-out, more specifically with the longitudinal axis thereof in parallel to the main plane of a brake disk that protrudes into the first cut-out in the installed state,

in a second step, the mounting is rotated about an axis in the direction of the longitudinal extension of the other limb of the “L”, so that the machining tool faces the brake application-side caliper section,

in a third step, the machining tool is moved toward the brake application-side caliper section, and

in a fourth step, the support surface is formed.

In other words, in light of the particular geometry, the machining tool is first introduced with a lateral orientation into the first or the second cut-out, and hence into the interior of the caliper, and only thereafter is it rotated into an orientation that is suited for machining the support surface and moved toward the support surface to be formed. This takes into account the difficulty that the “widths” of the first and second cut-outs are generally smaller than the “length” of the limb of the “L” comprising the machining tool.

In addition, or as an alternative, the machining tool may also comprise an L-shaped mounting and, for displacement into a working position, may be adjustable in a translatory and rotatory fashion about an axis that is perpendicular to the two limbs of the “L” with respect to the caliper.

Again, the “adjustability with respect to the caliper” denotes not only adjustability of the machining tool with a stationary caliper, but also adjustability of the caliper with a stationary tool, and adjustability of both the caliper and the tool.

The preferred method according to the invention can be carried out using the aforementioned adjustability in both a translatory and a rotatory fashion about an axis that is perpendicular to the two limbs of the “L” with respect to the caliper, wherein

in a first step, the limb of the “L” comprising the machining tool is displaced into the first or the second cut-out, more specifically it is positioned at a predetermined angle with the longitudinal axis thereof with respect to the main plane of a brake disk that protrudes into the first cut-out in the installed state,

in a second step, the machining tool is moved toward the brake application-side caliper section,

in a third step, the machining tool is pivoted about the axis that is perpendicular to both limbs of the “L” with respect to the caliper, so that the limb of the “L” comprising the machining tool is located, with the longitudinal axis thereof, perpendicular to the main plane of a brake disk protruding into the first cut-out in the installed state, and

in a fourth step, the support surface is formed.

According to this embodiment, the problem of the length of the limb of the “L” comprising the machining tool being larger than the widths of the first and second cut-outs is solved by introducing the machining tool “obliquely” through the first or second cut-out into the interior of the caliper.

According to the invention, the pitch may be 30° to 80°, preferably 40° to 70°, with 50° to 60° being particularly preferred.

The exact pitch that is established is, of course, dependent on the respective geometric conditions.

The method according to the invention also covers a version in which the brake application-side caliper section comprises at least one guide surface for holding and/or guiding a brake pad, a pressure piece, at least one pressure spindle device and/or at least one plunger device in the radial and/or circumferential directions of the brake, wherein in order to form the guide surface, a machining tool is moved through the first or second cut-out into that region in which the guide surface is to be formed.

In other words, according to the invention, a machining tool that is introduced through the first or second cut-out into the interior of the caliper is used not only to form the support surface, but the same applies to forming a guide surface.

In addition to the aforementioned method, the invention also creates a machining tool for carrying out the method, and particularly one that comprises an L-shaped mounting.

According to the invention, it is also preferred for the machining tool to comprise a form cutter, for example a face miller, a ball nose cutter or a plain milling cutter.

The selection of the form cutter depends on the design of the support or guide surface to be formed.

In addition, the invention creates a caliper of a disk brake, particularly for commercial vehicles, that is produced according to the method described above.

To this end, it is also preferred according to the invention for the support surface to be designed to support a rotating shaft of a brake application device.

It is preferred when the rotating shaft acts eccentrically and is connected to a rotating lever.

To this end, the rotating lever is preferably disposed in the interior of the caliper.

Finally, the invention also creates a disk brake, particularly for commercial vehicles, comprising such a caliper.

The invention will be described in more detail hereinafter based on preferred embodiments and with reference to the enclosed drawings. In the drawings:

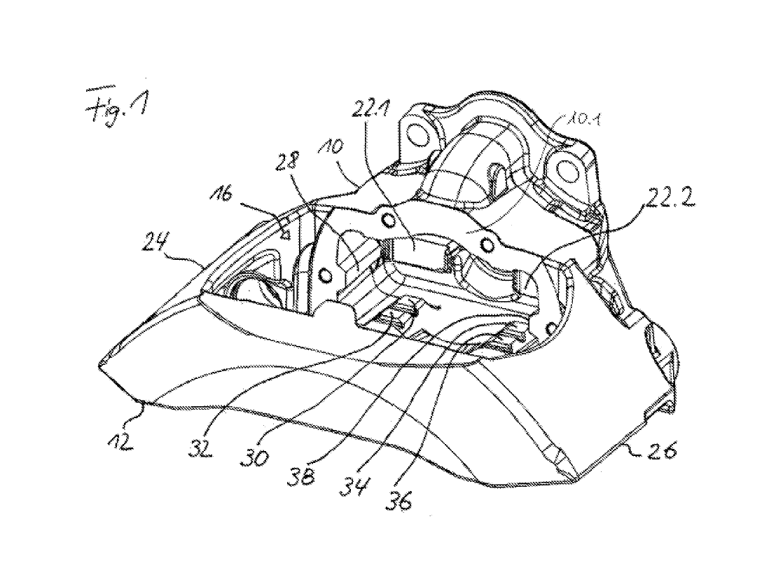

FIG. 1 shows a perspective view of a preferred embodiment of the brake caliper according to the invention, viewed from the rim side,

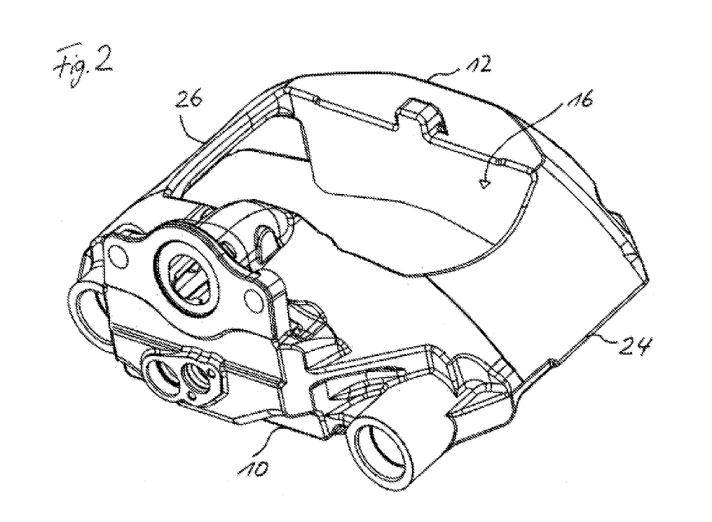

FIG. 2 is the same view as in FIG. 1, however viewed from the brake application side,

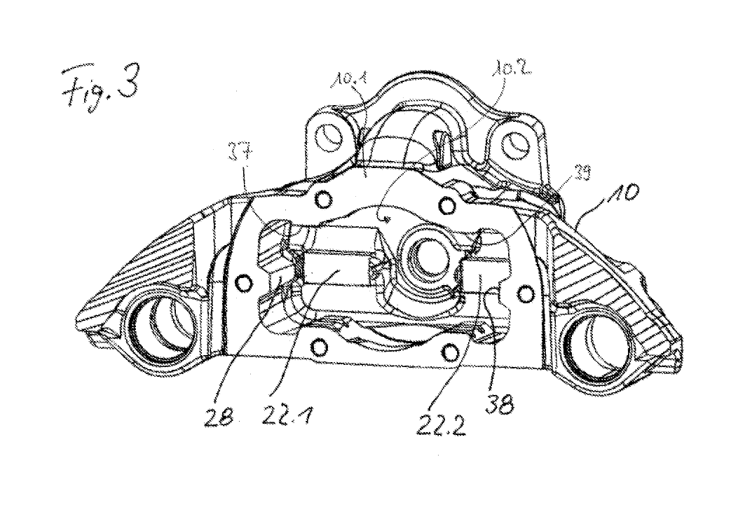

FIG. 3 is a perspective cross-sectional view of the section of the brake application-side caliper,

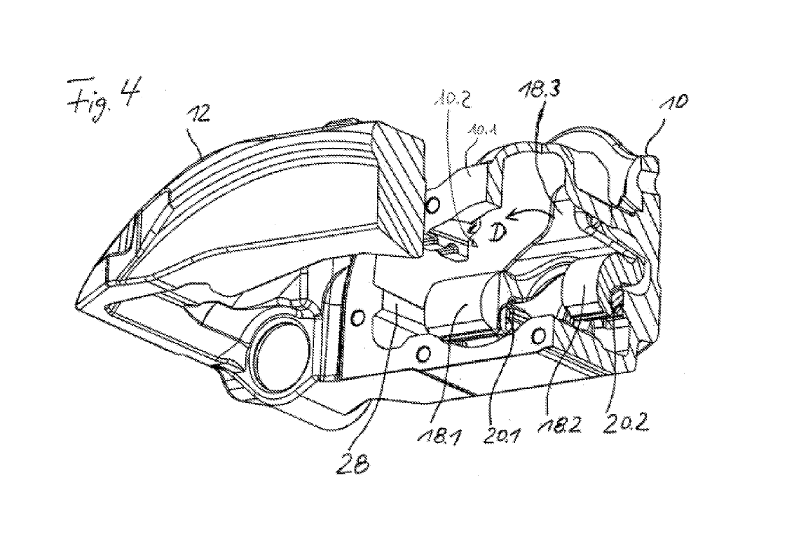

FIG. 4 is a perspective longitudinal section view of the caliper,

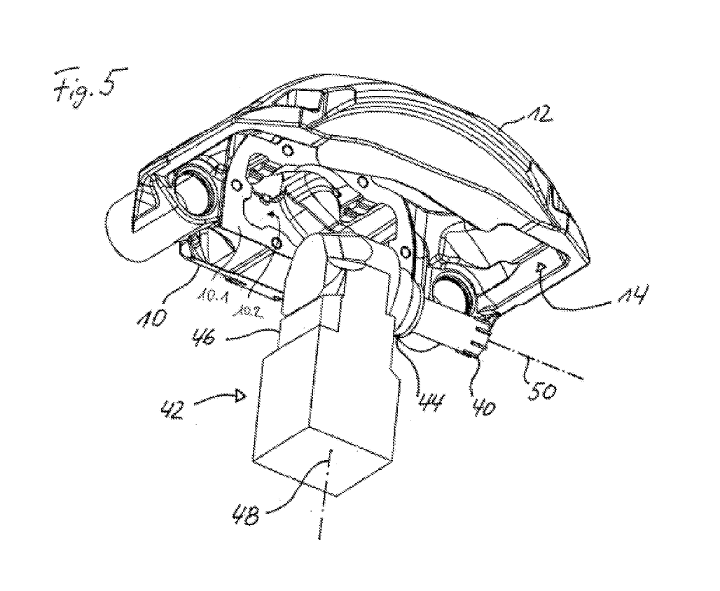

FIG. 5 is a perspective view of the caliper from radially inside, with a machining tool,

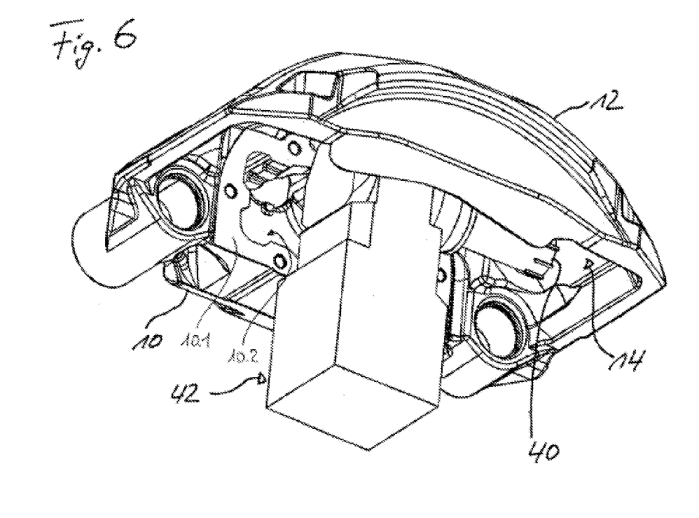

FIG. 6 is the same view as in FIG. 5, however with the machining tool in an advanced position,

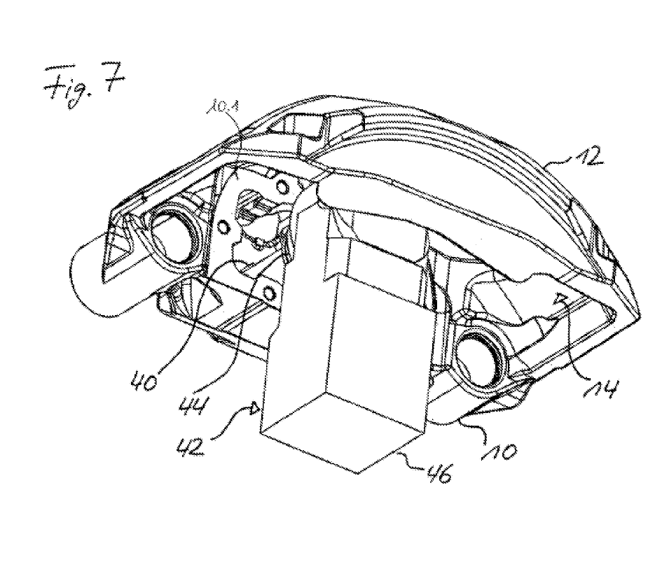

FIG. 7 is the same view as in FIG. 6, however with the machining tool in an even further advanced position,

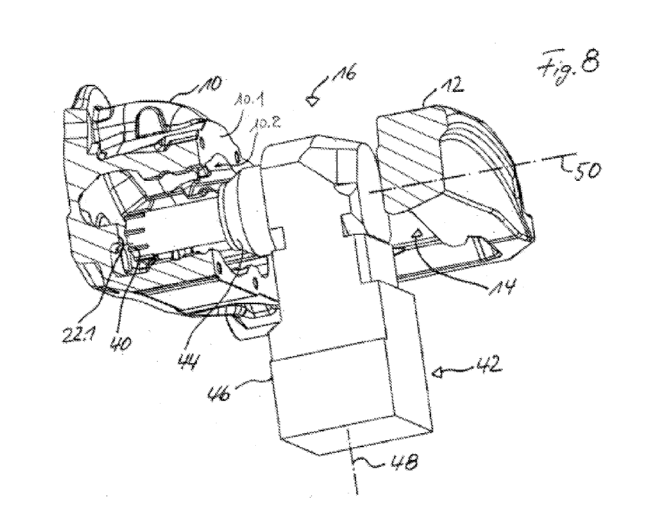

FIG. 8 is a perspective longitudinal section view with the machining tool in a working position, and

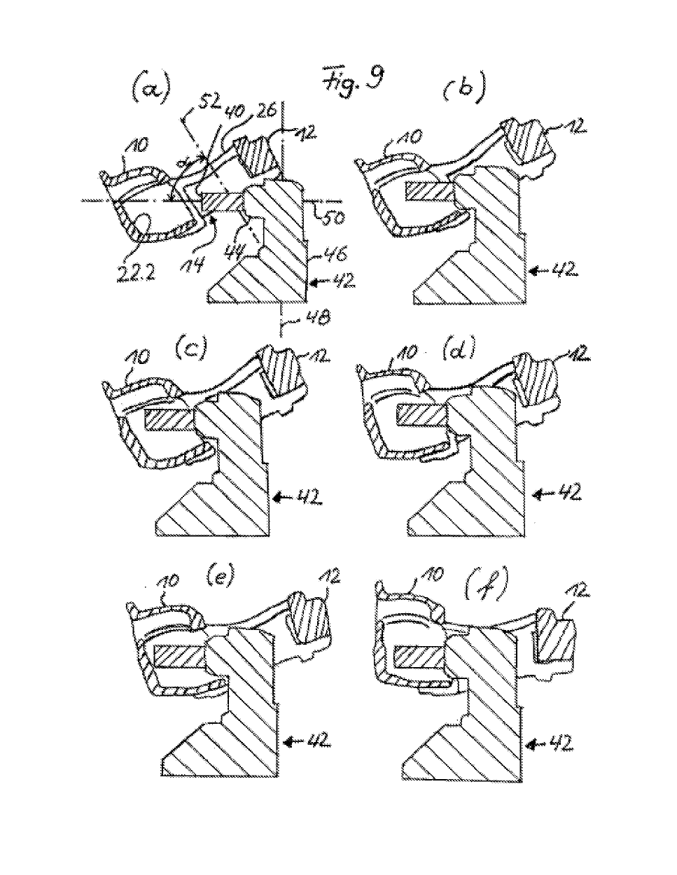

FIGS. 9(a) to (f) are schematic sectional views to explain an alternative production method.

The brake caliper shown in FIGS. 1 to 8 comprises a brake application-side caliper section 10 and a rim-side caliper section 12. The rim-side caliper section is (largely) closed, which contributes to a stable design. A first cut-out 14, which open radially inward, is located between the two caliper sections 10 and 12, see in particular FIG. 5. In addition, a second cut-out 16, which is open radially outward, is located between the caliper sections 10 and 12, see FIG. 1. In the installed state, a brake disk (not shown in the figure) protrudes into the first cut-out 14, so that part of the brake disk is located between the two caliper sections 10 and 12. The second cut-out 16 is used to install/remove brake pads (also not shown in the figure).

FIG. 4 shows a brake application shaft 18.1, 18.2, which is disposed in the interior of the brake caliper 10, 12 and supported by way of bearings 20.1, 20.2 on support surfaces 22.1, 22.2 (see FIGS. 1 and 3), and which, when pivoted in the rotational direction D, presses brake application parts disposed forward thereof, for example a brake pad, against the brake disk. The brake application shaft 18.1, 18.2 comprising a rotating lever 18.3 is part of a brake application device disposed in the brake caliper 10, 12, which is not shown in detail, as it is used in the disk brakes of commercial vehicles. In this design, the rotating lever 18.3 is also preferably disposed in the interior of the brake caliper 10, 12.

The two caliper sections 10 and 12 are designed integral with each other. They are connected to each other by webs 24, 26, which in the installed state extend over the brake disk.

According to FIG. 1, guide surfaces 28, 30, 32, 34, 36, 37, 38, 39 for holding and/or guiding a pressure piece and/or the brake application-side brake pad in the radial and/or circumferential directions of the brake disk are provided in the interior of the caliper or on the brake application-side caliper section 10. In addition to the shown guide surfaces, additional guide surfaces may be formed, which are used for further purpose, specifically to hold and/or guide a pressure spindle device and/or a plunger device, for example. The design of the brake application device is decisive for the designs/positions and number of the guide surfaces.

A flange surface 10.1 of the brake application-side caliper limb 10, to which a connecting frame can be attached, extends around an axial opening 10.2, by way of which the support surfaces 22.1 and 22.2 can be accessed. The axial opening 10.2 also serves the subsequent introduction of the parts of the brake application device mentioned above.

Hereinafter, a first example of a method for forming the support surfaces 22.1 and 22.2 will be described:

According to FIG. 5, a machining tool 40 in the form of a face miller having an L-shaped mounting 42 is introduced from radially inside through the first cut-out 14 into the caliper interior. In the installed state, a limb 44 of the “L” bearing the machining tool 40 is disposed parallel to a main plane of the brake disk. The insertion into the first cut-out is possible in this position, because the limb 44 of the “L” is shorter than the length of the first cut-out. In a position rotated 90° thereto, the limb 44 would not fit in the first cut-out 14 because the length thereof is larger than the width of the first cut-out 14.

After the machining tool 40 has been inserted upward, in FIG. 5, and into the interior space of the caliper, and has assumed the position shown in FIG. 6, a rotation about the longitudinal axis 48 of the limb 46 is carried out, so that the limb 44, according to FIG. 7, is directed at the support surfaces 22.1 and 22.2. As is particularly apparent from FIG. 8, in this position, the support surfaces 22.1 and 22.2 can be formed, using the face miller provided as the milling tool 40. The machining tool 40 runs along the respective surface to be machined so as to machine it. It should be noted that, of course, all support surface can also be designed to be continuous or as further partial surfaces.

In the embodiment shown, the guide surfaces 22.1 and 22.2 are flat. Using a ball nose mill, for example, as the machining tool, these support surfaces can also be designed in the manner of a groove having a circular arc-shaped contour.

After the support surfaces 22.1 and 22.2 have been formed, the machining tool 40 is moved back out of the interior of the caliper. The aforementioned movements are then carried out in reverse order.

The longitudinal axis of the limb 44 is denoted with reference numeral 50, see FIG. 8.

Below, a second example of a method for forming the support surfaces 22.1 and 22.2 is described, referencing FIG. 9.

Unlike in the first example, the machining tool 40 comprising the L-shaped mounting 42 is introduced into the first cut-out 14 in a position in which the longitudinal axis 50 of the limb 44 comprising the machining tool 40 is placed obliquely with respect to the main plane 52 of the brake disk (not shown). In the embodiment shown, the pitch a is approximately 55°, see FIG. 9(a).

According to FIG. 9(b), the tool 40 is then moved into the interior space of the caliper in a translatory fashion. Thereafter, according to FIG. 9(c), the mounting 42 is pivoted with the machining tool 40 with respect to the caliper about an axis perpendicular to the two longitudinal axes 48 and 50. To this end, the mounting 42 may be pivoted with the machining tool 40 with respect to the caliper. However, it is also possible to pivot the caliper with respect to the aforementioned elements. And it is possible to pivot both at the same time.

FIG. 9(d) shows a state in which the pivoting has progressed further as compared to FIG. 9(c).

As is apparent from FIG. 9(e), the mounting 42 is then pushed with the machining tool 40 in the drawing to the left, this being further into the interior space of the caliper.

FIG. 9(f) shows the working position in which the support surfaces 22.1 and 22.2 are formed using the machining tool 40.

The mounting 42, with the machining tool 40, is moved out in reverse order as that in which it is moved in.

The characteristics of the invention disclosed in the above description, in the claims and in the drawings may be essential for the implementation of the invention in its various embodiments either alone or in any random combination with each other.

1. A method for producing a brake caliper of a caliper-type disk brake, and particularly for commercial vehicles, the caliper comprising the following:
a brake application-side caliper section comprising at least one support surface for absorbing the clamping forces during braking,
a rim-side caliper section designed integral with the brake application-side caliper section, and
a first cut-out, which is located between the two caliper sections and into which at least some sections of at least one brake disk protrude in the installed state.
characterized in that
in order to form the support surface, a machining tool is moved through the first cut-out into that region in which the support surface is to be configured.

2. A method for producing a brake caliper of a caliper-type disk brake, and particularly for commercial vehicles, the caliper comprising the following:
a brake application-side caliper section comprising at least one support surface for absorbing the clamping forces during braking,
a rim-side caliper section designed integral with the brake application-side caliper section, and
a second cut-out located between the two caliper sections for installing/removing at least one brake pad,
characterized in that
in order to form the support surface, a machining tool is moved through the second cut-out into that region in which the support surface is to be form.

3. The method according to claim 1, characterized in that the support surface is flat at least in some sections.

4. A method according to claim 1, characterized in that the support surface, at least in some sections, has the shape of a groove.

5. The method according to claim 4, characterized in that the groove has an arc-shaped, and particularly a circular arc-shaped, contour.

6. A method according to claim 1, characterized in that the machining tool comprises an L-shaped mounting and, for the purpose of displacement into a working position, can be adjusted in a translatory and rotatory fashion about an axis in the direction of the longitudinal extension of one of the limbs of the “L” with respect to the caliper.

7. The method according to claim 6, characterized in that in a first step, the limb of the “L” comprising the machining tool is displaced into the first or the second cut-out, more specifically with the longitudinal axis thereof parallel to the main plane of a brake disk that protrudes into the first cut-out in the installed state,
in a second step, the mounting is rotated about an axis in the direction of the longitudinal extension of the other limb of the “L”, so that the machining tool faces the brake application-side caliper section,
in a third step, the machining tool is moved toward the brake application-side caliper section, and
in a fourth step, the support surface is formed.

8. A method according to claim 1, characterized in that the machining tool comprises an L-shaped mounting and, for the purpose of displacement into a working position, can be adjusted in a translatory and rotatory fashion about an axis that is perpendicular to the two limbs of the “L” with respect to the caliper.

9. The method according to claim 8, characterized in that in a first step, the limb of the “L” comprising the machining tool is displaced into the first or the second cut-out, more specifically it is positioned at a predetermined angle (α) with the longitudinal axis thereof with respect to the main plane of a brake disk that protrudes into the first cut-out in the installed state,
in a second step, the machining tool is moved toward the brake application-side caliper section,
in a third step, the machining tool is pivoted about the axis that is perpendicular to both limbs of the “L” with respect to the caliper, so that the limb of the “L” comprising the machining tool is located with the longitudinal axis thereof perpendicular to the main plane of a brake disk protruding into the first cut-out in the installed state, and
in a fourth step, the support surface is formed.

10. The method according to claim 9, characterized in that the pitch (α) is 30° to 80°, preferably 40° to 70°, with 50° to 60° being particularly preferred.

11. A method according to claim 1, the brake application-side caliper section comprising at least one guide surface for holding and/or guiding a brake pad, a pressure piece, at least one pressure spindle device and/or at least one plunger device in the radial and/or circumferential directions of the brake disk, characterized in that
in order to form the guide surface, a machining tool is moved through the second cut-out into that region in which the support surface is to be formed.

12. A machining tool for carrying out the method according to claim 1.

13. The machining tool according to claim 12, characterized in that it comprises an L-shaped mounting.

14. The machining tool according to claim 12, characterized in that it comprises a form cutter, for example a face miller, a ball nose cutter or a plain milling cutter.

15. A caliper of a brake disk, particularly for commercial vehicles, produced by the method according to claim 1.

16. The caliper according to claim 15, characterized in that the support surface is designed to support a rotating shaft of a brake application device.

17. The caliper according to claim 16, characterized in that the rotating shaft acts eccentrically and is connected to a rotating lever.

18. The caliper according to claim 17, characterized in that the rotating lever is disposed in the interior of the caliper.

19. A disk brake, particularly for commercial vehicles, comprising a caliper according to claim 15.
